(19) United States
(12) Patent Application Publication
(10) Pub. No.: US 2018/0199261 A1
(43) Pub. Date: Jul. 12, 2018

(54) METHOD AND APPARATUS FOR PERFORMING ACCESS BARRING CHECK FOR HIGH PRIORITY ACCESS IN WIRELESS COMMUNICATION SYSTEM

(71) Applicant: LG ELECTRONICS INC., Seoul (KR)

(72) Inventors: Youngdae LEE, Seoul (KR); Jaehyun KIM, Seoul (KR)

(73) Assignee: LG ELECTRONICS INC., Seoul (KR)

(21) Appl. No.: 15/755,793

(22) PCT Filed: Sep. 9, 2016
(86) PCT No.: PCT/KR2016/010136

§ 371 Date: Feb. 27, 2018

Related U.S. Application Data
(60) Provisional application No. 62/217,020, filed on Sep. 10, 2015.

(51) Int. Cl. H04W 48/02; H04W 48/16; H04W 48/08; H04W 76/10; H04W 74/00

(52) U.S. Cl. CPC H04W 48/02; H04W 48/16; H04W 12/08; H04W 76/10; H04W 74/002; H04W 48/08

(57) ABSTRACT

A method and apparatus for performing access class barring (ACB) in a wireless communication system is provided. A radio resource control (RRC) layer of a user equipment (UE) receives an indicator indicating whether a request of RRC connection establishment corresponds to mobile originating (MO) data or MO signaling from a non-access stratum (NAS) layer of the UE, and performs access barring check according to the indicator.

### TECHNICAL FIELD

The present invention relates to wireless communications, and more particularly, to a method and apparatus for performing access barring check for high priority access in a wireless communication system.

### BACKGROUND ART

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

A radio access control (RRC) connection establishment is used to make the transition from RRC idle mode to RRC connected mode. A user equipment (UE) must make the transition to RRC connected mode before transferring any application data, or completing any signaling procedures. The RRC connection establishment procedure is always initiated by the UE but can be triggered by either the UE or the network. For example, the UE may trigger RRC connection establishment if the end-user starts an application to browse the internet, or to send an email. Similarly, the UE may trigger RRC connection establishment if the UE moves into a new tracking area and has to complete the tracking area update signaling procedure. The network may trigger the RRC connection establishment procedure by sending a paging message.

Under certain circumstances, it will be desirable to prevent UEs from making access attempts (including emergency call attempts) or responding to pages in specified areas of a public land mobile network (PLMN). Such situations may arise during states of emergency, or where 1 of 2 or more co-located PLMNs has failed. Broadcast messages should be available on a cell by cell basis indicating the class(es) or categories of sub-scribers barred from network access. The use of these facilities allows the network operator to prevent overload of the access channel under critical conditions. It is not intended that access control be used under normal operating conditions. It should be possible to differentiate access control between circuit-switched (CS) and packet-switched (PS) domains.

### DISCLOSURE OF INVENTION

### Technical Problem

The present invention provides a method and apparatus for performing access barring check for high priority access in a wireless communication system. The present invention provides an interaction between a non-access stratum (NAS) layer and a radio resource control (RRC) layer for access class barring (ACB) skipping user equipment (UE) operation.

### Solution to Problem

In an aspect, a method for performing access class barring (ACB) by a user equipment (UE) in a wireless communication system is provided. The method includes receiving, by a radio resource control (RRC) layer of the UE, an indicator indicating whether a request of RRC connection establishment corresponds to mobile originating (MO) data or MO signaling from a non-access stratum (NAS) layer of the UE, and performing, by the RRC layer of the UE, access barring check according to the indicator.

In another aspect, a user equipment (UE) in a wireless communication system is provided. The UE includes a memory, a transceiver, and a processor, coupled to the memory and the transceiver, that receives an indicator indicating whether a request of a radio resource control (RRC) connection establishment corresponds to mobile originating (MO) data or MO signaling from a non-access stratum (NAS) layer of the UE, and performs access barring check according to the indicator.

### Advantageous Effects of Invention

For access barring check of high priority access, whether to use ACB barring parameters for mobile originating (MO) signaling or ACB barring parameters for MO data can be defined clearly.

### BRIEF DESCRIPTION OF DRAWINGS

FIG. 1 shows LTE system architecture.

FIG. 2 shows a block diagram of architecture of a typical E-UTRAN and a typical EPC.

FIG. 3 shows a block diagram of a user plane protocol stack of an LTE system.

FIG. 4 shows a block diagram of a control plane protocol stack of an LTE system.

FIG. 5 shows an example of a physical channel structure.

FIG. 6 shows a method for performing ACB according to an embodiment of the present invention.

FIG. 7 shows a method for performing ACB according to another embodiment of the present invention.

FIG. 8 shows a wireless communication system to implement an embodiment of the present invention.

### MODE FOR THE INVENTION

The technology described below can be used in various wireless communication systems such as code division multiple access (CDMA), frequency division multiple access (FDMA), time division multiple access (TDMA), orthogonal frequency division multiple access (OFDMA), single carrier frequency division multiple access (SC-FDMA), etc. The CDMA can be implemented with a radio technology such as universal terrestrial radio access (UTRA) or CDMA-2000. The TDMA can be implemented with a radio technology such as global system for mobile communications (GSM)/general packet ratio service (GPRS)/enhanced data rate for GSM evolution (EDGE). The OFDMA can be implemented with a radio technology such as institute of electrical and electronics engineers (IEEE) 802.11 (Wi-Fi), IEEE 802.16 (WiMAX), IEEE 802-20, evolved UTRA (E-UTRA), etc. IEEE 802.16m is an evolution of IEEE 802.16e, and provides backward compatibility with an IEEE 802.16-based system. The UTRA is a part of a universal mobile telecommunication system (UMTS). 3rd generation partnership project (3GPP) long term evolution (LTE) is a part of an evolved UMTS (E-UMTS) using the E-UTRA. The 3GPP LTE uses the OFDMA in downlink and uses the SC-FDMA in uplink LTE-advance (LTE-A) is an evolution of the 3GPP LTE.

For clarity, the following description will focus on the LTE-A. However, technical features of the present invention are not limited thereto.

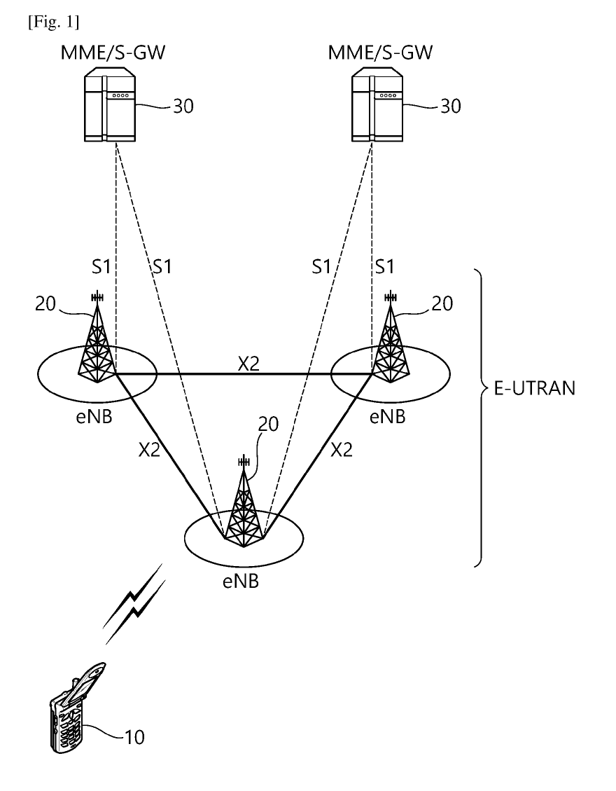

FIG. 1 shows LTE system architecture. The communication network is widely deployed to provide a variety of communication services such as voice over internet protocol (VoIP) through IMS and packet data.

Referring to FIG. 1, the LTE system architecture includes one or more user equipment (UE; 10), an evolved-UMTS terrestrial radio access network (E-UTRAN) and an evolved packet core (EPC). The UE 10 refers to a communication equipment carried by a user. The UE 10 may be fixed or mobile, and may be referred to as another terminology, such as a mobile station (MS), a user terminal (UT), a subscriber station (SS), a wireless device, etc.

The E-UTRAN includes one or more evolved node-B (eNB) 20, and a plurality of UEs may be located in one cell. The eNB 20 provides an end point of a control plane and a user plane to the UE 10. The eNB 20 is generally a fixed station that communicates with the UE 10 and may be referred to as another terminology, such as a base station (BS), an access point, etc. One eNB 20 may be deployed per cell.

Hereinafter, a downlink (DL) denotes communication from the eNB 20 to the UE 10, and an uplink (UL) denotes communication from the UE 10 to the eNB 20. In the DL, a transmitter may be a part of the eNB 20, and a receiver may be a part of the UE 10. In the UL, the transmitter may be a part of the UE 10, and the receiver may be a part of the eNB 20.

The EPC includes a mobility management entity (MME) and a system architecture evolution (SAE) gateway (S-GW). The MME/S-GW 30 may be positioned at the end of the network and connected to an external network. For clarity, MME/S-GW 30 will be referred to herein simply as a “gateway,” but it is understood that this entity includes both the MME and S-GW.

The MME provides various functions including non-access stratum (NAS) signaling to eNBs 20, NAS signaling security, access stratum (AS) security control, inter core network (CN) node signaling for mobility between 3GPP access networks, idle mode UE reachability (including control and execution of paging retransmission), tracking area list management (for UE in idle and active mode), packet data network (PDN) gateway (P-GW) and S-GW selection, MME selection for handovers with MME change, serving GPRS support node (SGSN) selection for handovers to 2G or 3G 3GPP access networks, roaming, authentication, bearer management functions including dedicated bearer establishment, support for public warning system (PWS) (which includes earthquake and tsunami warning system (ETWS) and commercial mobile alert system (CMAS)) message transmission. The S-GW host provides assorted functions including per-user based packet filtering (by e.g., deep packet inspection), lawful interception, UE Internet protocol (IP) address allocation, transport level packet marking in the DL, UL and DL service level charging, gating and rate enforcement, DL rate enforcement based on access point name aggregate maximum bit rate (APN-AMBR).

Interfaces for transmitting user traffic or control traffic may be used. The UE 10 is connected to the eNB 20 via a Uu interface. The eNBs 20 are connected to each other via an X2 interface. Neighboring eNBs may have a meshed network structure that has the X2 interface. A plurality of nodes may be connected between the eNB 20 and the gateway 30 via an S1 interface.

FIG. 2 shows a block diagram of architecture of a typical E-UTRAN and a typical EPC. Referring to FIG. 2, the eNB 20 may perform functions of selection for gateway 30, routing toward the gateway 30 during a radio resource control (RRC) activation, scheduling and transmitting of paging messages, scheduling and transmitting of broadcast channel (BCH) information, dynamic allocation of resources to the UEs 10 in both UL and DL, configuration and provisioning of eNB measurements, radio bearer control, radio admission control (RAC), and connection mobility control in LTE_ACTIVE state. In the EPC, and as noted above, gateway 30 may perform functions of paging origination, LTE_IDLE state management, ciphering of the user plane, SAE bearer control, and ciphering and integrity protection of NAS signaling.

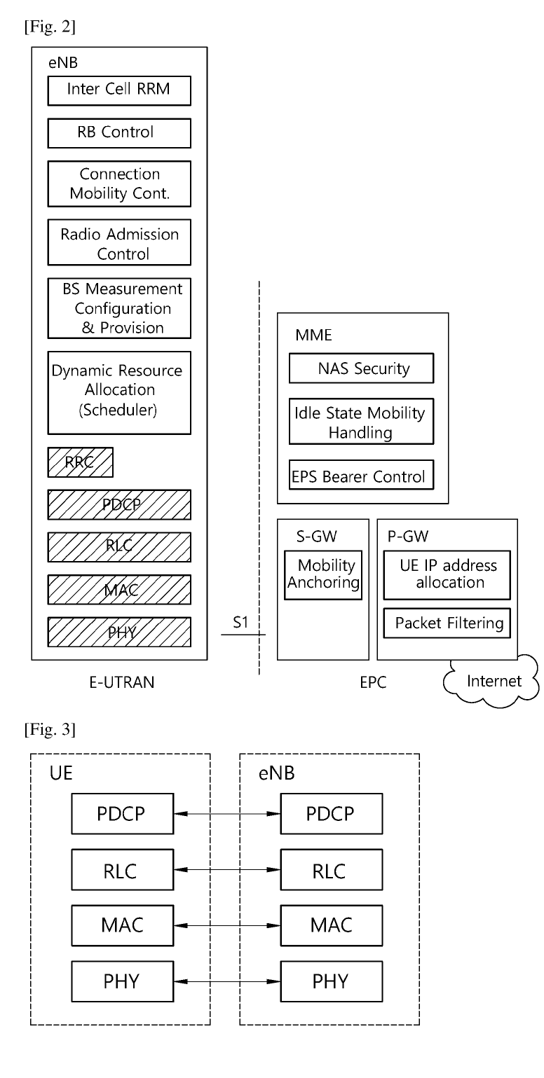

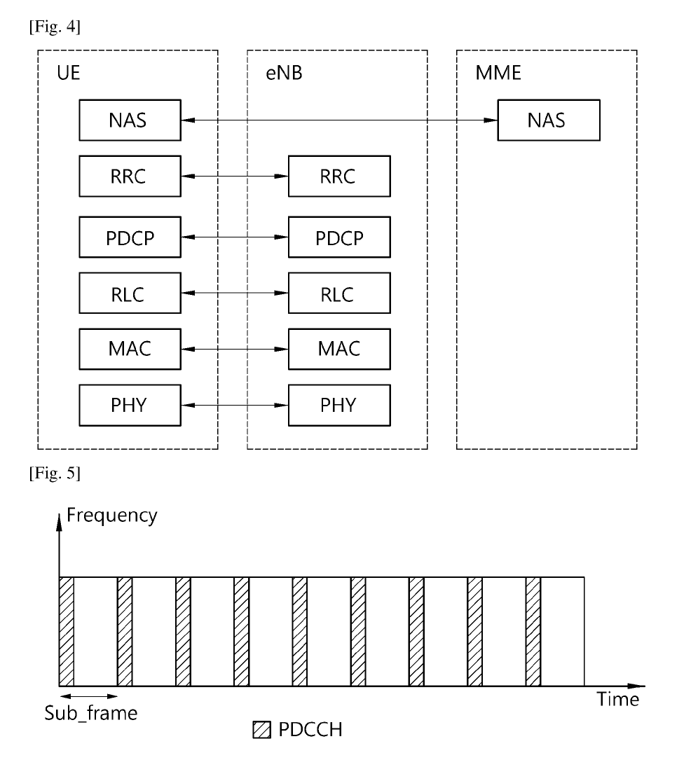

FIG. 3 shows a block diagram of a user plane protocol stack of an LTE system. FIG. 4 shows a block diagram of a control plane protocol stack of an LTE system. Layers of a radio interface protocol between the UE and the E-UTRAN may be classified into a first layer (L1), a second layer (L2), and a third layer (L3) based on the lower three layers of the open system interconnection (OSI) model that is well-known in the communication system.

A physical (PHY) layer belongs to the L1. The PHY layer provides a higher layer with an information transfer service through a physical channel. The PHY layer is connected to a medium access control (MAC) layer, which is a higher layer of the PHY layer, through a transport channel. A physical channel is mapped to the transport channel. Data between the MAC layer and the PHY layer is transferred through the transport channel. Between different PHY layers, i.e., between a PHY layer of a transmission side and a PHY layer of a reception side, data is transferred via the physical channel.

A MAC layer, a radio link control (RLC) layer, and a packet data convergence protocol (PDCP) layer belong to the L2. The MAC layer provides services to the RLC layer, which is a higher layer of the MAC layer, via a logical channel. The MAC layer provides data transfer services on logical channels. The RLC layer supports the transmission of data with reliability. Meanwhile, a function of the RLC layer may be implemented with a functional block inside the MAC layer. In this case, the RLC layer may not exist. The PDCP layer provides a function of header compression function that reduces unnecessary control information such that data being transmitted by employing IP packets, such as IPv4 or Ipv6, can be efficiently transmitted over a radio interface that has a relatively small bandwidth.

A radio resource control (RRC) layer belongs to the L3. The RLC layer is located at the lowest portion of the L3, and is only defined in the control plane. The RRC layer controls logical channels, transport channels, and physical channels in relation to the configuration, reconfiguration, and release of radio bearers (RBs). The RB signifies a service provided the L2 for data transmission between the UE and E-UTRAN.

Referring to FIG. 3, the RLC and MAC layers (terminated in the eNB on the network side) may perform functions such as scheduling, automatic repeat request (ARQ), and hybrid ARQ (HARM). The PDCP layer (terminated in the eNB on the network side) may perform the user plane functions such as header compression, integrity protection, and ciphering.

Referring to FIG. 4, the RLC and MAC layers (terminated in the eNB on the network side) may perform the same functions for the control plane. The RRC layer (terminated in the eNB on the network side) may perform functions such as broadcasting, paging, RRC connection management, RB control, mobility functions, and UE measurement reporting and controlling. The NAS control protocol (terminated in the MME of gateway on the network side) may perform functions such as a SAE bearer management, authentication, LTE_IDLE mobility handling, paging origination in LTE_IDLE, and security control for the signaling between the gateway and UE.

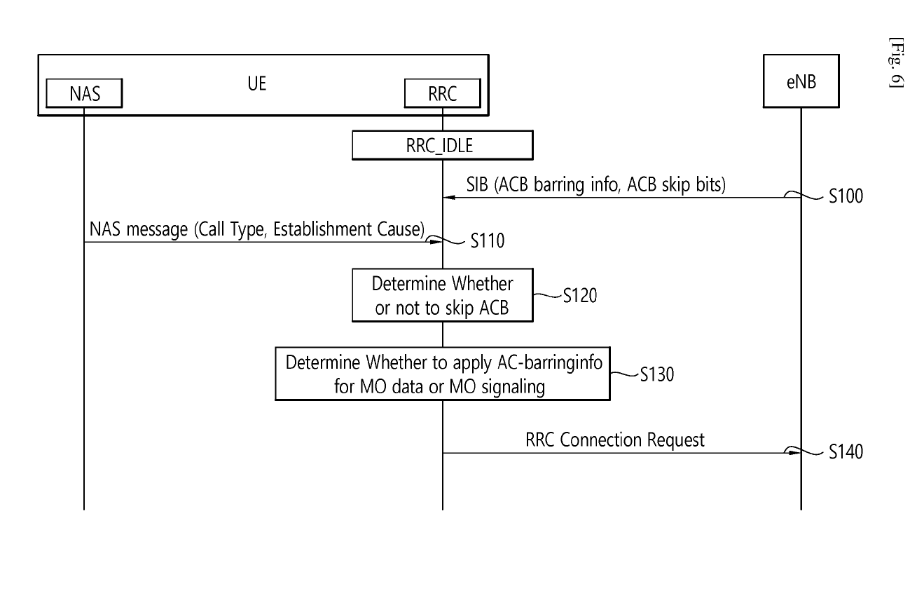

FIG. 5 shows an example of a physical channel structure. A physical channel transfers signaling and data between PHY layer of the UE and eNB with a radio resource. A physical channel consists of a plurality of subframes in time domain and a plurality of subcarriers in frequency domain. One subframe, which is lms, consists of a plurality of symbols in the time domain. Specific symbol(s) of the subframe, such as the first symbol of the subframe, may be used for a physical downlink control channel (PDCCH). The PDCCH carries dynamic allocated resources, such as a physical resource block (PRB) and modulation and coding scheme (MCS).

A DL transport channel includes a broadcast channel (BCH) used for transmitting system information, a paging channel (PCH) used for paging a UE, a downlink shared channel (DL-SCH) used for transmitting user traffic or control signals, a multicast channel (MCH) used for multicast or broadcast service transmission. The DL-SCH supports HARQ, dynamic link adaptation by varying the modulation, coding and transmit power, and both dynamic and semi-static resource allocation. The DL-SCH also may enable broadcast in the entire cell and the use of beamforming.

A UL transport channel includes a random access channel (RACH) normally used for initial access to a cell, an uplink shared channel (UL-SCH) for transmitting user traffic or control signals, etc. The UL-SCH supports HARQ and dynamic link adaptation by varying the transmit power and potentially modulation and coding. The UL-SCH also may enable the use of beamforming.

The logical channels are classified into control channels for transferring control plane information and traffic channels for transferring user plane information, according to a type of transmitted information. That is, a set of logical channel types is defined for different data transfer services offered by the MAC layer.

The control channels are used for transfer of control plane information only. The control channels provided by the MAC layer include a broadcast control channel (BCCH), a paging control channel (PCCH), a common control channel (CCCH), a multicast control channel (MCCH) and a dedicated control channel (DCCH). The BCCH is a downlink channel for broadcasting system control information. The PCCH is a downlink channel that transfers paging information and is used when the network does not know the location cell of a UE. The CCCH is used by UEs having no RRC connection with the network. The MCCH is a point-to-multipoint downlink channel used for transmitting multimedia broadcast multicast services (MBMS) control information from the network to a UE. The DCCH is a point-to-point bi-directional channel used by UEs having an RRC connection that transmits dedicated control information between a UE and the network.

Traffic channels are used for the transfer of user plane information only. The traffic channels provided by the MAC layer include a dedicated traffic channel (DTCH) and a multicast traffic channel (MTCH). The DTCH is a point-to-point channel, dedicated to one UE for the transfer of user information and can exist in both uplink and downlink The MTCH is a point-to-multipoint downlink channel for transmitting traffic data from the network to the UE.

Uplink connections between logical channels and transport channels include the DCCH that can be mapped to the UL-SCH, the DTCH that can be mapped to the UL-SCH and the CCCH that can be mapped to the UL-SCH. Downlink connections between logical channels and transport channels include the BCCH that can be mapped to the BCH or DL-SCH, the PCCH that can be mapped to the PCH, the DCCH that can be mapped to the DL-SCH, and the DTCH that can be mapped to the DL-SCH, the MCCH that can be mapped to the MCH, and the MTCH that can be mapped to the MCH.

An RRC state indicates whether an RRC layer of the UE is logically connected to an RRC layer of the E-UTRAN. The RRC state may be divided into two different states such as an RRC idle state (RRC_IDLE) and an RRC connected state (RRC_CONNECTED). In RRC_IDLE, the UE may receive broadcasts of system information and paging information while the UE specifies a discontinuous reception (DRX) configured by NAS, and the UE has been allocated an identification (ID) which uniquely identifies the UE in a tracking area and may perform public land mobile network (PLMN) selection and cell re-selection. Also, in RRC_IDLE, no RRC context is stored in the eNB.

In RRC_CONNECTED, the UE has an E-UTRAN RRC connection and a context in the E-UTRAN, such that transmitting and/or receiving data to/from the eNB becomes possible. Also, the UE can report channel quality information and feedback information to the eNB. In RRC_CONNECTED, the E-UTRAN knows the cell to which the UE belongs. Therefore, the network can transmit and/or receive data to/from UE, the network can control mobility (handover and inter-radio access technologies (RAT) cell change order to GSM EDGE radio access network (GERAN) with network assisted cell change (NACC)) of the UE, and the network can perform cell measurements for a neighboring cell.

In RRC_IDLE, the UE specifies the paging DRX cycle. Specifically, the UE monitors a paging signal at a specific paging occasion of every UE specific paging DRX cycle. The paging occasion is a time interval during which a paging signal is transmitted. The UE has its own paging occasion. A paging message is transmitted over all cells belonging to the same tracking area. If the UE moves from one tracking area (TA) to another TA, the UE will send a tracking area update (TAU) message to the network to update its location.

RRC connection establishment is described. It may be referred to as Section 5.3 of 3GPP TS 36.331 V12.5.0 (2015-03). The purpose of this procedure is to establish an RRC connection. RRC connection establishment involves signaling radio bearer (SRB)-1 establishment. The procedure is also used to transfer the initial NAS dedicated information/message from the UE to E-UTRAN.

The UE initiates the procedure when upper layers (i.e. NAS layer) request establishment of an RRC connection while the UE is in RRC_IDLE. When the UE is in evolved packet system (EPS) mobility management (EMM) idle mode and needs to transmit an initial NAS message, the UE shall request the lower layer (i.e. RRC layer) to establish a RRC connection. In this request to the lower layer, the NAS shall provide to the lower layer the RRC establishment cause and the call type. Specifically, when EMM requests the establishment of a NAS-signaling connection, the RRC establishment cause used by the UE shall be selected according to the NAS procedure. The EMM shall also indicate to the lower layer for the purpose of access control, the call type associated with the RRC establishment cause.

Table 1 shows a part of mapping of tracking area update procedure to establishment cause and call type.

TABLE 1

| RRC establishment cause | Call type |
|---|---|
| If the UE does not have a PDN connection established for | “originating |
| emergency bearer services and is not initiating a PDN | signalling” |
| CONNECTIVITY REQUEST that has request type set to | |
| “emergency”, and MO MMTEL voice call is not started, | |
| MO MMTEL video call is not started, MO SMSoIP is not | |
| started, MO SMS over NAS or MO SMS over S102 is not | |
| requested, the RRC establishment cause shall be set to | |
| MO signalling. | |
| If the UE does not have a PDN connection established for | “originating |
| emergency bearer services and is not initiating a PDN | MMTEL |
| CONNECTIVITY REQUEST that has request type set to | voice” |
| “emergency”, and an MO MMTEL voice call is started, | |
| the RRC establishment cause shall be set to MO signalling. | |
| If the UE does not have a PDN connection established for | “originating |
| emergency bearer services and is not initiating a PDN | MMTEL |
| CONNECTIVITY REQUEST that has request type set to | video” |
| “emergency”, and an MO MMTEL video call is started, | |
| the RRC establishment cause shall be set to MO signalling. | |
| If the UE does not have a PDN connection established for | “originating |
| emergency bearer services and is not initiating a PDN | SMSoIP” |
| CONNECTIVITY REQUEST that has request type set | |
| to “emergency”, and an MO SMSoIP is started, the RRC | |
| establishment cause shall be set to MO signalling. | |
| If the UE does not have a PDN connection established for | “originating |
| emergency bearer services and is not initiating a PDN | SMS” |
| CONNECTIVITY REQUEST that has request type set to | |
| “emergency”, and an MO SMS over NAS or MO SMS | |
| over S102 is requested, the RRC establishment cause | |
| shall be set to MO signalling. | |
| If the UE does not have a PDN connection established for | “originating |
| emergency bearer services and is not initiating a PDN | signalling” |
| CONNECTIVITY REQUEST that has request type set to | |
| “emergency”, the tracking area update procedure is not | |
| triggered due to paging, a TRACKING AREA UPDATE | |
| REQUEST contains the Device properties IE with low | |
| priority indicator set to “MS is configured for NAS | |
| signalling low priority”, and MO MMTEL voice call is | |
| not started, MO MMTEL video call is not started, MO | |
| SMSoIP is not started, MO SMS over NAS or MO | |
| SMS over S102 is not requested, the RRC establishment | |
| cause shall be set to Delay tolerant. | |
| If the UE does not have a PDN connection established | “originating |
| for emergency bearer services and is not initiating a PDN | MMTEL |
| CONNECTIVITY REQUEST that has request type set to | voice” |
| “emergency”, an MO MMTEL voice call is started, and a | |
| TRACKING AREA UPDATE REQUEST contains the | |
| Device properties IE with low priority indicator set to | |
| “MS is configured for NAS signalling low priority”, the | |
| RRC establishment cause shall be set to MO signalling. | |
| If the UE does not have a PDN connection established for | “originating |
| emergency bearer services and is not initiating a PDN | MMTEL |
| CONNECTIVITY REQUEST that has request type set to | video” |
| “emergency”, an MO MMTEL video call is started, and a | |
| TRACKING AREA UPDATE REQUEST contains the | |
| Device properties IE with low priority indicator set to | |
| “MS is configured for NAS signalling low priority”, the | |
| RRC establishment cause shall be set to MO signalling. | |
| If the UE does not have a PDN connection established for | “originating |
| emergency bearer services and is not initiating a PDN | SMSoIP” |
| CONNECTIVITY REQUEST that has request type set to | |
| “emergency”, an MO SMSoIP is started, and a TRACK- | |
| ING AREA UPDATE REQUEST contains the Device | |
| properties IE with low priority indicator set to “MS is | |
| configured for NAS signalling low priority”, the RRC | |
| establishment cause shall be set to MO signalling. | |
| If the UE does not have a PDN connection established for | “originating |
| emergency bearer services and is not initiating a PDN | SMS” |
| CONNECTIVITY REQUEST that has request type set to | |
| “emergency”, an MO SMS over NAS or MO SMS over | |
| S102 is requested, and a TRACKING AREA UPDATE | |
| REQUEST contains the Device properties IE with low | |
| priority indicator set to “MS is configured for NAS | |
| signalling low priority”, the RRC establishment cause | |
| shall be set to MO signalling. | |
| . . . | . . . |

Referring to Table 1, for various cases of tracking area update procedure, the RRC establishment cause, which will be used by the UE for transmission of the RRCConnectionRequest message, and the call type are defined.

Table 2 shows a part of mapping of service request procedure to establishment cause and call type.

TABLE 2

| RRC establishment cause | Call type |
|---|---|
| If a SERVICE REQUEST is to request user plane radio | “originating |
| resources and MO MMTEL voice call is not started, MO | calls” |
| MMTEL video call is not started and MO SMSoIP is | |
| not started, the RRC establishment cause shall be set to | |
| MO data. | |
| If a SERVICE REQUEST is to request user plane radio | “originating |
| resources and an MO MMTEL voice call is started, the | MMTEL |
| RRC establishment cause shall be set to MO data. | voice” |
| If a SERVICE REQUEST is to request user plane radio | “originating |
| resources and an MO MMTEL video call is started, the | MMTEL |
| RRC establishment cause shall be set to MO data. | video” |
| If a SERVICE REQUEST is to request user plane radio | “originating |
| resources and an MO SMSoIP is started, the RRC | SMSoIP” |
| establishment cause shall be set to MO data. | |
| . . . | . . . |
| If a SERVICE REQUEST is to request resources for UL | “originating |
| signalling and not for MO SMS over NAS or MO SMS | calls” |
| over S102, the RRC establishment cause shall be set to | |
| MO data. | |
| If a SERVICE REQUEST is to request resources for UL | “originating |
| signalling for MO SMS over NAS or MO SMS over | SMS” |
| S102, the RRC establishment cause shall be set to MO | |
| data. | |
| If a SERVICE REQUEST is to request user plane radio | “originating |
| resources or to request resources for UL signalling and | calls” |
| the UE is configured for dual priority and the NAS | |
| signalling low priority indicator is overridden, the RRC | |
| establishment cause shall be set to MO data. | |
| . . . | . . . |
| If a SERVICE REQUEST is to request user plane radio | “originating |
| resources or to request resources for UL signalling, the | calls” |
| UE is configured for NAS signalling low priority, and | |
| MO MMTEL voice call is not started, MO MMTEL | |
| video call is not started and MO SMSoIP is not started, | |
| MO SMS over NAS or MO SMS over S102 is not | |
| requested, the RRC establishment cause shall be set to | |
| Delay tolerant. | |
| If a SERVICE REQUEST is to request user plane radio | “originating |
| resources, an MO MMTEL voice call is started, and the | MMTEL |
| UE is configured for NAS signalling low priority, the | voice” |
| RRC establishment cause shall be set to MO data. | |
| If a SERVICE REQUEST is to request user plane radio | “originating |
| resources, an MO MMTEL video call is started, and the | MMTEL |
| UE is configured for NAS signalling low priority, the | video” |
| RRC establishment cause shall be set to MO data. | |
| If a SERVICE REQUEST is to request user plane radio | “originating |
| resources, an MO SMSoIP is started, and the UE is | SMSoIP” |
| configured for NAS signalling low priority, the RRC | |
| establishment cause shall be set to MO data. | |
| If a SERVICE REQUEST is to request resources for | “originating |
| UL signalling for MO SMS over NAS or MO SMS over | SMS” |
| S102 and the UE is configured for NAS signalling low | |
| priority, the RRC establishment cause shall be set to | |
| MO data. | |
| . . . | . . . |
| If an EXTENDED SERVICE REQUEST contains the | “originating |
| Device properties IE with low priority indicator set to | calls” |
| “MS is not configured for NAS signalling low priority”, | |
| and MO MMTEL voice call is not started, MO MMTEL | |
| video call is not started and MO SMSoIP is not started, | |
| MO SMS over NAS or MO SMS over S102 is not | |
| requested, the RRC establishment cause shall be set to | |
| MO data. | |
| If an EXTENDED SERVICE REQUEST contains the | “originating |
| Device properties IE with low priority indicator set to | MMTEL |
| “MS is not configured for NAS signalling low priority” | voice” |
| and an MO MMTEL voice call is started, the RRC | |
| establishment cause shall be set to MO data. | |
| If an EXTENDED SERVICE REQUEST contains the | “originating |
| Device properties IE with low priority indicator set to | MMTEL |
| “MS is not configured for NAS signalling low priority” | video” |
| and an MO MMTEL video call is started, the RRC | |
| establishment cause shall be set to MO data. | |
| If an EXTENDED SERVICE REQUEST contains the | “originating |
| Device properties IE with low priority indicator set to | SMSoIP” |
| “MS is not configured for NAS signalling low priority” | |
| and an MO SMSoIP is started, the RRC establishment | |
| cause shall be set to MO data. | |
| If an EXTENDED SERVICE REQUEST contains the | “originating |
| Device properties IE with low priority indicator set to | SMS” |
| “MS is not configured for NAS signalling low priority” | |
| and an MO SMS over NAS or MO SMS over S102 is | |
| requested, the RRC establishment cause shall be set to | |
| MO data. | |
| If an EXTENDED SERVICE REQUEST contains the | “originating |
| Device properties IE with low priority indicator set to | calls” |
| “MS is configured for NAS signalling low priority”, | |
| and MO MMTEL voice call is not started, MO MMTEL | |
| video call is not started and MO SMSoIP is not started, | |
| MO SMS over NAS or MO SMS over S102 is not | |
| requested, the RRC establishment cause shall be set to | |
| Delay tolerant. | |
| If an EXTENDED SERVICE REQUEST contains the | “originating |
| Device properties IE with low priority indicator set to | MMTEL |
| “MS is configured for NAS signalling low priority” and | voice” |
| an MO MMTEL voice call is started, the RRC | |
| establishment cause shall be set to MO data. | |
| If an EXTENDED SERVICE REQUEST contains the | “originating |
| Device properties IE with low priority indicator set to | MMTEL |
| “MS is configured for NAS signalling low priority” and | video” |
| an MO MMTEL video call is started, the RRC | |
| establishment cause shall be set to MO data. | |
| If an EXTENDED SERVICE REQUEST contains the | “originating |
| Device properties IE with low priority indicator set to | SMSoIP” |
| “MS is configured for NAS signalling low priority” | |
| and an MO SMSoIP is started, the RRC establishment | |
| cause shall be set to MO data. | |
| If an EXTENDED SERVICE REQUEST contains the | “originating |
| Device properties IE with low priority indicator set to | SMS” |
| “MS is configured for NAS signalling low priority” and | |
| an MO SMS over NAS or MO SMS over S102 is | |
| requested, the RRC establishment cause shall be set to | |
| MO data. | |
| . . . | . . . |

Referring to Table 2, for various cases of service request procedure, the RRC establishment cause, which will be used by the UE for transmission of the RRCConnectionRequest message, and the call type are defined.

Further, for the tracking area update and service request procedures initiated by UEs of access class 12, 13 or 14 in their home country, the RRC establishment cause will be set to “High priority access AC 11-15”.

Upon initiation of the procedure, the UE shall:
1> if the UE is establishing the RRC connection for mobile terminating (MT) calls:
2> if timer T302 is running:
3> inform upper layers about the failure to establish the RRC connection and that access barring for mobile terminating calls is applicable, upon which the procedure ends;
1> else if the UE is establishing the RRC connection for emergency calls:
2> if SystemInformationBlockType2 includes the ac-BarringInfo:
3> if the ac-BarringForEmergency is set to TRUE:
4> if the UE has one or more access classes, as stored on the universal subscriber identification module (USIM), with a value in the range 11 . . . 15, which is valid for the UE to use:
5> if the ac-BarringInfo includes ac-BarringForMO-Data, and for all of these valid Access Classes for the UE, the corresponding bit in the ac-BarringForSpecialAC contained in ac-BarringForMO-Data is set to one:
6> consider access to the cell as barred;
4> else:
5> consider access to the cell as barred;
2> if access to the cell is barred:
3> inform upper layers about the failure to establish the RRC connection, upon which the procedure ends;
1> else if the UE is establishing the RRC connection for mobile originating (MO) calls:
2> perform access barring check, using T303 as “Tbarring” and ac-BarringForMO-Data as access class barring (ACB) parameter;
2> if access to the cell is barred:
3> if SystemInformationBlockType2 includes ac-BarringForCSFB or the UE does not support circuit-switched (CS) fallback:
4> inform upper layers about the failure to establish the RRC connection and that access barring for mobile originating calls is applicable, upon which the procedure ends;
3> else (SystemInformationBlockType2 does not include ac-BarringForCSFB and the UE supports CS fallback):
4> if timer T306 is not running, start T306 with the timer value of T303;
4> inform upper layers about the failure to establish the RRC connection and that access barring for mobile originating calls and mobile originating CS fallback is applicable, upon which the procedure ends;
1> else if the UE is establishing the RRC connection for mobile originating signaling:
2> perform access barring check, using T305 as “Tbarring” and ac-BarringForMO-Signalling as ACB parameter;
2> if access to the cell is barred:
3> inform upper layers about the failure to establish the RRC connection and that access barring for mobile originating signalling is applicable, upon which the procedure ends;
1> else if the UE is establishing the RRC connection for mobile originating CS fallback:
2> if SystemInformationBlockType2 includes ac-BarringForCSFB:
3> perform access barring check, using T306 as “Tbarring” and ac-BarringForCSFB as ACB parameter;
3> if access to the cell is barred:
4> inform upper layers about the failure to establish the RRC connection and that access barring for mobile originating CS fallback is applicable, due to ac-BarringForCSFB, upon which the procedure ends;
2> else:
3> perform access barring check, using T306 as “Tbarring” and ac-BarringForMO-Data as ACB parameter;
3> if access to the cell is barred:
4> if timer T303 is not running, start T303 with the timer value of T306;
4> inform upper layers about the failure to establish the RRC connection and that access barring for mobile originating CS fallback and mobile originating calls is applicable, due to ac-BarringForMO-Data, upon which the procedure ends;
1> else if the UE is establishing the RRC connection for mobile originating multimedia telephony (MMTEL) voice, mobile originating MMTEL video, mobile originating short message service over IP (SMSoIP) or mobile originating SMS:
2> if the UE is establishing the RRC connection for mobile originating MMTEL voice and SystemInformationBlockType2 includes ac-BarringSkipForMMTELVoice; or
2> if the UE is establishing the RRC connection for mobile originating MMTEL video and SystemInformationBlockType2 includes ac-BarringSkipForMMTELVideo; or
2> if the UE is establishing the RRC connection for mobile originating SMSoIP or SMS and SystemInformationBlockType2 includes ac-BarringSkipForSMS:
3> consider access to the cell as not barred;
2> else:
3> if establishmentCause is set to mo-Signalling:
4> perform access barring check, using T305 as “Tbarring” and ac-BarringForMO-Signalling as ACB parameter;
4> if access to the cell is barred:
5> inform upper layers about the failure to establish the RRC connection and that access barring for mobile originating signalling is applicable, upon which the procedure ends;
3> if establishmentCause is set to mo-Data:
4> perform access barring check, using T303 as “Tbarring” and ac-BarringForMO-Data as ACB parameter;
4> if access to the cell is barred:
5> if SystemInformationBlockType2 includes ac-BarringForCSFB or the UE does not support CS fallback:
6> inform upper layers about the failure to establish the RRC connection and that access barring for mobile originating calls is applicable, upon which the procedure ends;
5> else (SystemInformationBlockType2 does not include ac-BarringForCSFB and the UE supports CS fallback):
6> if timer T306 is not running, start T306 with the timer value of T303;
6> inform upper layers about the failure to establish the RRC connection and that access barring for mobile originating calls and mobile originating CS fallback is applicable, upon which the procedure ends;
1> initiate transmission of the RRCConnectionRequest message.

The UE shall set the contents of RRCConnectionRequest message as follows:

1> set the ue-Identity as follows:

2> if upper layers provide an SAE temporary mobile subscriber identity (S-TMSI):

3> set the ue-Identity to the value received from upper layers;

2> else:

3> draw a random value in the range 0 . . . 2⁴⁰-4 and set the ue-Identity to this value;

1> set the establishmentCause in accordance with the information received from upper layers;

The UE shall submit the RRCConnectionRequest message to lower layers for transmission.

ACB is described. It may be referred to as Section 5.3.3.11 of 3GPP TS 36.331 V12.5.0 (2015-03).
1> if timer T302 or “Tbarring” is running:
2> consider access to the cell as barred;
1> else if SystemInformationBlockType2 includes ACB parameter:
2> if the UE has one or more access classes, as stored on the USIM, with a value in the range 11 . . . 15, which is valid for the UE to use, and

2> for at least one of these valid access classes the corresponding bit in the ac-BarringForSpecialAC contained in ACB parameter is set to zero:
3> consider access to the cell as not barred;
2> else:
3> draw a random number ‘rand’ uniformly distributed in the range: 0≤rand<1;
3> if ‘rand’ is lower than the value indicated by ac-BarringFactor included in ACB parameter:
4> consider access to the cell as not barred;
3> else:
4> consider access to the cell as barred;
1> else:
2> consider access to the cell as not barred;
1> if access to the cell is barred and both timers T302 and “Tbarring” are not running:
2> draw a random number ‘rand’ that is uniformly distributed in the range 0≤rand<1;
2> start timer “Tbarring” with the timer value calculated as follows, using the ac-BarringTime included in ACB parameter:

“Tbarring”=(0.7+0.6*rand)*ac-BarringTime.

The ACB parameter described above in the RRC connection establishment procedure is defined in SystemInformationBlockType2 information element (IE). The SystemInformationBlockType2 IE contains radio resource configuration information that is common for all UEs. Table 3 shows a part of the SystemInformationBlockType2 IE including the ACB parameter.

TABLE 3
-- ASN1STARTSystemInformationBlockType2 ::= SEQUENCE {ac-
BarringInfo SEQUENCE {ac-BarringForEmergency BOOLEAN,ac-
BarringForMO-Signalling AC-BarringConfig OPTIONAL, -- Need OPac-
BarringForMO-Data AC-BarringConfig OPTIONAL -- Need OP}
OPTIONAL, -- Need OP ...[[ac-BarringSkipForMMTELVoice-r12
ENUMERATED {true} OPTIONAL, -- Need OPac-
BarringSkipForMMTELVideo-r12 ENUMERATED {true} OPTIONAL,
-- Need OPac-BarringSkipForSMS-r12 ENUMERATED {true}
OPTIONAL, -- Need OPac-BarringPerPLMN-List-r12 AC-
BarringPerPLMN-List-r12 OPTIONAL -- Need OP]]}...AC-
BarringConfig ::= SEQUENCE {ac-BarringFactor ENUMERATED
{p00, p05, p10, p15, p20, p25, p30, p40,p50, p60, p70, p75, p80, p85,
p90, p95 },ac-BarringTime ENUMERATED { s4, s8, s16, s32, s64,
s128, s256, s512},ac-BarringForSpecialAC BIT STRING
(SIZE(5))}AC-BarringPerPLMN-List-r12 ::= SEQUENCE (SIZE (1..
maxPLMN-r11)) OF AC-BarringPerPLMN-r12AC-BarringPerPLMN-
r12 ::= SEQUENCE {plmn-IdentityIndex-r12 INTEGER (1..maxPLMN-
r11),ac-BarringInfo-r12 SEQUENCE {ac-BarringForEmergency-r12
BOOLEAN,ac-BarringForMO-Signalling-r12 AC-BarringConfig
OPTIONAL, -- Need OPac-BarringForMO-Data-r12 AC-BarringConfig
OPTIONAL -- Need OP} OPTIONAL, -- Need OPac-
BarringSkipForMMTELVoice-r12 ENUMERATED {true}
OPTIONAL, -- Need OPac-BarringSkipForMMTELVideo-r12
ENUMERATED {true} OPTIONAL, -- Need OPac-
BarringSkipForSMS-r12 ENUMERATED {true} OPTIONAL,
-- Need OPac-BarringForCSFB-r12 AC-BarringConfig OPTIONAL,
-- Need OPssac-BarringForMMTEL-Voice-r12 AC-BarringConfig
OPTIONAL, -- Need OPssac-BarringForMMTEL-Video-r12 AC-
BarringConfig OPTIONAL -- Need OP}-- ASN1STOP

Referring to Table 3, the SystemInformationBlockType2 IE may include the ac-Bar-ringForMO-Signalling IE and the ac-BarringForMO-Data IE. The ac-BarringForMO-Signalling IE corresponds to ACB parameter for MO signaling. The ac-BarringForMO-Data IE corresponds to ACB parameter for MO calls (i.e. MO data). Each AC parameter (i.e. the AC-BarringConfig IE) includes ac-BarringFactor, ac-BarringTime and ac-BarringForSpecialAC. If the random number drawn by the UE is lower than ac-BarringFactor, access is allowed. Otherwise the access is barred. The values are interpreted in the range [0,1): p00=0, p05=0.05, p10=0.10, . . . , p95=0.95. Values other than p00 can only be set if all bits of the corresponding ac-BarringForSpecialAC are set to 0. ac-BarringTime indicates access barring time value in seconds.ac-BarringForSpecialAC indicates ACB for AC 11-15. The first/leftmost bit is for AC 11, the second bit is for AC 12, and so on.

Further, the SystemInformationBlockType2 IE may include ac-BarringSkipForMMTELVoice, ac-BarringSkipForMMTELVideo, ac-BarringSkipForSMS. If each bit is present and set to true, ACB for the corresponding service may be skipped.

As described above, currently if the UE is establishing the RRC connection for MO MMTEL voice, MO MMTEL video, MO SMSoIP or MO SMS, and ACB skip bit for the corresponding service is not included in the SystemInformationBlockType2 IE, ACB is performed for the corresponding service by using ACB parameters for MO-signaling or ACB parameters for MO-data. Whether to use ACB parameters for MO-signaling or ACB parameters for MO-data is determined by the establishmentCause received from NAS layer. That is, if the establishmentCause is set to mo-Signalling, ACB is performed by using ACB parameters for MO-signaling, and if the establishmentCause is set to mo-Data, ACB is performed by using ACB parameters for MO-data.

However, for the tracking area update and service request procedures initiated by UEs of access class 12, 13 or 14 in their home country, the establishmentCause may be set to high priority access. In this case, it is not clear how the RRC layer of the UE applies ACB for either MO-signaling or MO-data when the UE cannot skip ACB. More specifically, when ACB for MO MMTEL voice, MO MMTEL video, MO SMSoIP or MO SMS is not skipped but the establishmentCause received from the NAS layer is be set to high priority access, there is ambiguity about how to apply ACB for either MO-signaling or MO-data. Accordingly, a method for solving the problem described above may be required.

FIG. 6 shows a method for performing ACB according to an embodiment of the present invention.

In step S100, the RRC layer of the UE receives system information, i.e. SIB2. The RRC layer of the UE may acquire ac-BarringForMO-Signalling and ac-BarringForMO-Data from SIB2. Further, the RRC layer of the UE may acquire ACB skip bits for MMTEL voice, MMTEL video and SMS from SIB2.

In step S110, the NAS layer of the UE determines to perform either tracking area update or service request and so requests RRC connection establishment procedure to the RRC layer of the UE. The NAS layer of the UE may request RRC connection establishment procedure due to tracking area update or service request for one of MO MMTEL voice, MO MMTEL video, MO SMSoIP or MO SMS. In this case, the NAS layer of the UE may indicate the following information related to ACB operation to the RRC layer of the UE according to one of the following options. Hereinafter, each option is described in detail.

(1) Option 1

The NAS layer of the UE may indicate one of the following call types to the RRC layer of the UE.
A call type mapped to originating MMTEL voice for data (in case of service request for MMTEL voice service);
A call type mapped to originating MMTEL voice for signaling (in case of tracking area update for MMTEL voice service);
A call type mapped to originating MMTEL video for data (in case of service request for MMTEL video service);
A call type mapped to originating MMTEL video for signaling (in case of tracking area update for MMTEL video service);
A call type mapped to originating SMSoIP for data (in case of service request for SMSoIP service);
A call type mapped to originating SMSoIP for signaling (in case of tracking area update for SMSoIP service);
A call type mapped to originating SMS for data (in case of service request for SMS service);
A call type mapped to originating SMS for signaling (in case of tracking area update for SMS service)

Currently, call types mapped to originating MMTEL voice, originating MMTEL video, originating SMSoIP and originating SMS are defined. On the other hand, according to the option (1) of the present invention, call types mapped to originating MMTEL voice for data and signaling, originating MMTEL video for data and signaling, originating SMSoIP for data and signaling, and originating SMS for data and signaling are defined. That is, each call type currently defined for the corresponding service is separately configured for originating data and originating signaling. Accordingly, whether the corresponding service is originating signaling or originating data can be indicated to the RRC layer of the UE.

Table 4 shows a part of mapping of tracking area update procedure to establishment cause and call type according to an embodiment of the present invention. Table 4 is modification of Table 1.

TABLE 4

| RRC establishment cause | Call type |
|---|---|
| If the UE does not have a PDN connection established for | “originating |
| emergency bearer services and is not initiating a PDN | signalling” |
| CONNECTIVITY REQUEST that has request type | |
| set to “emergency”, and MO MMTEL voice call is | |
| not started, MO MMTEL video call is not started, MO | |
| SMSoIP is not started, MO SMS over NAS or MO | |
| SMS over S102 is not requested, the RRC establishment | |
| cause shall be set to MO signalling. | |
| If the UE does not have a PDN connection established for | “originating |
| emergency bearer services and is not initiating a PDN | MMTEL |
| CONNECTIVITY REQUEST that has request type set to | voice” |
| “emergency”, and an MO MMTEL voice call is started, | |
| the RRC establishment cause shall be set to MO signalling. | |
| If the UE does not have a PDN connection established for | “originating |
| emergency bearer services and is not initiating a PDN | MMTEL |
| CONNECTIVITY REQUEST that has request type set to | video” |
| “emergency”, and an MO MMTEL video call is started, | |
| the RRC establishment cause shall be set to MO signalling. | |
| If the UE does not have a PDN connection established for | “originating |
| emergency bearer services and is not initiating a PDN | SMSoIP” |
| CONNECTIVITY REQUEST that has request type set to | |
| “emergency”, and an MO SMSoIP is started, the RRC | |
| establishment cause shall be set to MO signalling. | |
| If the UE does not have a PDN connection established for | “originating |
| emergency bearer services and is not initiating a PDN | SMS” |
| CONNECTIVITY REQUEST that has request type set to | |
| “emergency”, and an MO SMS over NAS or MO SMS | |
| over S102 is requested, the RRC establishment cause shall | |
| be set to MO signalling. | |
| If the UE does not have a PDN connection established for | “originating |
| emergency bearer services and is not initiating a PDN | signalling” |
| CONNECTIVITY REQUEST that has request type set | |
| to “emergency”, the tracking area update procedure is not | |
| triggered due to paging, a TRACKING AREA UPDATE | |
| REQUEST contains the Device properties IE with low | |
| priority indicator set to “MS is configured for NAS | |
| signalling low priority”, and MO MMTEL voice call is not | |
| started, MO MMTEL video call is not started, MO SMSoIP | |
| is not started, MO SMS over NAS or MO SMS over S102 | |
| is not requested, the RRC establishment cause shall be set | |
| to Delay tolerant. | |
| If the UE does not have a PDN connection established for | “originating |
| emergency bearer services and is not initiating a PDN | MMTEL |
| CONNECTIVITY REQUEST that has request type set to | voice for |
| “emergency”, an MO MMTEL voice call is started, and a | signalling” |
| TRACKING AREA UPDATE REQUEST contains the | |
| Device properties IE with low priority indicator set to | |
| “MS is configured for NAS signalling low priority”, the | |
| RRC establishment cause shall be set to MO signalling. | |
| If the UE does not have a PDN connection established for | “originating |
| emergency bearer services and is not initiating a PDN | MMTEL |
| CONNECTIVITY REQUEST that has request type set to | video for |
| “emergency”, an MO MMTEL video call is started, and a | signalling” |
| TRACKING AREA UPDATE REQUEST contains the | |
| Device properties IE with low priority indicator set to | |
| “MS is configured for NAS signalling low priority”, the | |
| RRC establishment cause shall be set to MO signalling. | |
| If the UE does not have a PDN connection established for | “originating |
| emergency bearer services and is not initiating a PDN | SMSoIP for |
| CONNECTIVITY REQUEST that has request type set to | signalling” |
| “emergency”, an MO SMSoIP is started, and a | |
| TRACKING AREA UPDATE REQUEST contains the | |
| Device properties IE with low priority indicator set to | |
| “MS is configured for NAS signalling low priority”, the | |
| RRC establishment cause shall be set to MO signalling. | |
| If the UE does not have a PDN connection established for | “originating |
| emergency bearer services and is not initiating a PDN | SMS for |
| CONNECTIVITY REQUEST that has request type set to | signalling” |
| “emergency”, an MO SMS over NAS or MO SMS over | |
| S102 is requested, and a TRACKING AREA UPDATE | |
| REQUEST contains the Device properties IE with low | |
| priority indicator set to “MS is configured for NAS | |
| signalling low priority”, the RRC establishment cause | |
| shall be set to MO signalling. | |
| . . . | . . . |

Referring to Table 4, “originating MMTEL voice for signaling”, “originating MMTEL video for signaling”, “originating SMSoIP for signaling” and “originating SMS for signaling” are newly defined for call type. The call type “originating . . . for signaling” may be replaced with “originating . . . signaling” or “originating signaling for . . . ”.

Table 5 shows a part of mapping of service request procedure to establishment cause and call type according to an embodiment of the present invention. Table 5 is modification of Table 2.

TABLE 5

| RRC establishment cause | Call type |
|---|---|
| If a SERVICE REQUEST is to request user plane radio | “originating |
| resources and MO MMTEL voice call is not started, MO | calls” |
| MMTEL video call is not started and MO SMSoIP is not | |
| started, the RRC establishment cause shall be set to MO | |
| data. | |
| If a SERVICE REQUEST is to request user plane radio | “originating |
| resources and an MO MMTEL voice call is started, the | MMTEL voice |
| RRC establishment cause shall be set to MO data. | for data” |
| If a SERVICE REQUEST is to request user plane radio | “originating |
| resources and an MO MMTEL video call is started, the | MMTEL video |
| RRC establishment cause shall be set to MO data. | for data” |
| If a SERVICE REQUEST is to request user plane radio | “originating |
| resources and an MO SMSoIP is started, the RRC | SMSoIP for |
| establishment cause shall be set to MO data. | data” |
| . . . | . . . |
| If a SERVICE REQUEST is to request resources for UL | “originating |
| signalling and not for MO SMS over NAS or MO SMS | calls” |
| over S102, the RRC establishment cause shall be set to | |
| MO data. | |
| If a SERVICE REQUEST is to request resources for UL | “originating |
| signalling for MO SMS over NAS or MO SMS over | SMS for data” |
| S102, the RRC establishment cause shall be set to MO | |
| data. | |
| If a SERVICE REQUEST is to request user plane radio | “originating |
| resources or to request resources for UL signalling and | calls” |
| the UE is configured for dual priority and the NAS | |
| signalling low priority indicator is overridden, the RRC | |
| establishment cause shall be set to MO data. | |
| . . . | . . . |
| If a SERVICE REQUEST is to request user plane radio | “originating |
| resources or to request resources for UL signalling, the | calls” |
| UE is configured for NAS signalling low priority, and | |
| MO MMTEL voice call is not started, MO MMTEL | |
| video call is not started and MO SMSoIP is not started, | |
| MO SMS over NAS or MO SMS over S102 is not | |
| requested, the RRC establishment cause shall be set to | |
| Delay tolerant. | |
| If a SERVICE REQUEST is to request user plane radio | “originating |
| resources, an MO MMTEL voice call is started, and the | MMTEL voice |
| UE is configured for NAS signalling low priority, the | for data” |
| RRC establishment cause shall be set to MO data. | |
| If a SERVICE REQUEST is to request user plane radio | “originating |
| resources, an MO MMTEL video call is started, and the | MMTEL video |
| UE is configured for NAS signalling low priority, the | for data” |
| RRC establishment cause shall be set to MO data. | |
| If a SERVICE REQUEST is to request user plane radio | “originating |
| resources, an MO SMSoIP is started, and the UE is | SMSoIP for |
| configured for NAS signalling low priority, the RRC | data” |
| establishment cause shall be set to MO data. | |
| If a SERVICE REQUEST is to request resources for UL | “originating |
| signalling for MO SMS over NAS or MO SMS over | SMS for data” |
| S102 and the UE is configured for NAS signalling low | |
| priority, the RRC establishment cause shall be set to | |
| MO data. | |
| . . . | . . . |
| If an EXTENDED SERVICE REQUEST contains the | “originating |
| Device properties IE with low priority indicator set to | calls” |
| “MS is not configured for NAS signalling low priority”, | |
| and MO MMTEL voice call is not started, MO MMTEL | |
| video call is not started and MO SMSoIP is not started, | |
| MO SMS over NAS or MO SMS over S102 is not | |
| requested, the RRC establishment cause shall be set to | |
| MO data. | |
| If an EXTENDED SERVICE REQUEST contains the | “originating |
| Device properties IE with low priority indicator set to | MMTEL voice |
| “MS is not configured for NAS signalling low priority” | for data” |
| and an MO MMTEL voice call is started, the RRC | |
| establishment cause shall be set to MO data. | |
| If an EXTENDED SERVICE REQUEST contains the | “originating |
| Device properties IE with low priority indicator set to | MMTEL video |
| “MS is not configured for NAS signalling low priority” | for data” |
| and an MO MMTEL video call is started, the RRC | |
| establishment cause shall be set to MO data. | |
| If an EXTENDED SERVICE REQUEST contains the | “originating |
| Device properties IE with low priority indicator set to | SMSoIP for |
| “MS is not configured for NAS signalling low priority” | data” |
| and an MO SMSoIP is started, the RRC | |
| establishment cause shall be set to MO data. | |
| If an EXTENDED SERVICE REQUEST contains | “originating |
| the Device properties IE with low priority indicator | SMS for data” |
| set to “MS is not configured for NAS signalling low | |
| priority” and an MO SMS over NAS or MO SMS | |
| over S102 is requested, the RRC establishment cause | |
| shall be set to MO data. | |
| If an EXTENDED SERVICE REQUEST contains the | “originating |
| Device properties IE with low priority indicator set to | calls” |
| “MS is configured for NAS signalling low priority”, | |
| and MO MMTEL voice call is not started, MO MMTEL | |
| video call is not started and MO SMSoIP is not started, | |
| MO SMS over NAS or MO SMS over S102 is not | |
| requested, the RRC establishment cause shall be set to | |
| Delay tolerant. | |
| If an EXTENDED SERVICE REQUEST contains the | “originating |
| Device properties IE with low priority indicator set to | MMTEL voice |
| “MS is configured for NAS signalling low priority” | for data” |
| and an MO MMTEL voice call is started, the RRC | |
| establishment cause shall be set to MO data. | |
| If an EXTENDED SERVICE REQUEST contains the | “originating |
| Device properties IE with low priority indicator set to | MMTEL video |
| “MS is configured for NAS signalling low priority” | for data” |
| and an MO MMTEL video call is started, the RRC | |
| establishment cause shall be set to MO data. | |
| If an EXTENDED SERVICE REQUEST contains the | “originating |
| Device properties IE with low priority indicator set to | SMSoIP for |
| “MS is configured for NAS signalling low priority” | data” |
| and an MO SMSoIP is started, the RRC establishment | |
| cause shall be set to MO data. | |
| If an EXTENDED SERVICE REQUEST contains the | “originating |
| Device properties IE with low priority indicator set to | SMS for data” |
| “MS is configured for NAS signalling low priority” | |
| and an MO SMS over NAS or MO SMS over S102 is | |
| requested, the RRC establishment cause shall be set to | |
| MO data. | |
| . . . | . . . |

Referring to Table 5, “originating MMTEL voice for data”, “originating MMTEL video for data”, “originating SMSoIP for data” and “originating SMS for data” are newly defined for call type. The call type “originating . . . for data” may be replaced with “originating . . . calls” or “originating calls for . . . ”.

(2) Option 2

The NAS layer of the UE may indicate the establishmentCause set to one of either MO-Signalling or MO-Data to the RRC layer of the UE. The NAS layer of the UE may indicate one of call types mapped to originating MMTEL voice, originating MMTEL video, originating SMSoIP, or originating SMS to the RRC layer of the UE. This is the same as the current procedure.

Further, The NAS layer of the UE may indicate a new indicator to the RRC layer of the UE. The new indicator may indicate whether this request of the RRC connection establishment corresponds to data (i.e. for service request) or signaling (i.e. for tracking area update) for the indicated call type. Accordingly, whether the corresponding service is originating signaling or originating data can be indicated to the RRC layer of the UE.

(3) Option 3

The NAS layer of the UE may indicate one of call types mapped to originating MMTEL voice, originating MMTEL video, originating SMSoIP, or originating SMS to the RRC layer of the UE. This is the same as the current procedure.

Further, NAS layer of the UE may indicate the establishmentCause set to one of MO—Signalling, MO-Data, HighPriorityAccess—Signaling (in case of tracking area update) or HighPriorityAccess-Data (in case of service request). In this case, for the tracking area update and service request procedures initiated by UEs of access class 11, 12, 13, 14 or 15, the RRC establishment cause may be set to “High priority access—data” (for service request) or “High priority access—signalling” (for tracking area update). Accordingly, whether the corresponding service is originating signaling or originating data can be indicated to the RRC layer of the UE.

Back to FIG. 6, in step S120, the RRC layer of the UE determines whether or not to skip ACB as follows:

2> if the UE is establishing the RRC connection for mobile originating MMTEL voice and SystemInformationBlockType2 includes ac-BarringSkipForMMTELVoice; or

2> if the UE is establishing the RRC connection for mobile originating MMTEL video and SystemInformationBlockType2 includes ac-BarringSkipForMMTELVideo; or

2> if the UE is establishing the RRC connection for mobile originating SMSoIP or SMS and SystemInformationBlockType2 includes ac-BarringSkipForSMS:

3> consider access to the cell as not barred;

2> else:

3> step S130 is performed.

Since it is determined not to skip ACB for the corresponding service in step S120, in step s130, the RRC layer of the UE determines whether to use ac-BarringForMO-Signalling or ac-BarringForMO-Data for ACB. According to which information is received from the NAS layer of the UE by each option in step S110, the RRC layer of the UE may perform one of the following operations by each option.

(1) Option 1

If the call type indicated by the NAS layer of the UE corresponds to one of originating MMTEL voice for signaling, originating MMTEL video for signaling, originating SMSoIP for signaling or originating SMS for signaling (i.e. for tracking area update) according to Table 4 described above, the RRC layer of the UE may perform access barring check, using T305 as “Tbarring” and ac-BarringForMO-Signalling as ACB parameter. Otherwise, i.e. if the call type indicated by the NAS layer of the UE corresponds to one of originating MMTEL voice for data, originating MMTEL video for data, originating SMSoIP for data or originating SMS for data (i.e. for service request) according to Table 5 described above, the RRC layer of the UE may perform access barring check, using T303 as “Tbarring” and ac-BarringForMO-Data as ACB parameter.

(2) Option 2

If the new indicator indicates that this request of the RRC connection establishment corresponds to signaling (i.e. for tracking area update) for the indicated call type, the RRC layer of the UE may perform access barring check, using T305 as “Tbarring” and ac-BarringForMO-Signalling as ACB parameter. Otherwise, i.e. if the new indicator indicates that this request of the RRC connection establishment corresponds to data (i.e. for service request), the RRC layer of the UE may perform access barring check, using T303 as “Tbarring” and ac-BarringForMO-Data as ACB parameter.

(2) Option 3

If the establishmentCause is set to MO-Signalling or HighPriorityAccess-signalling, the RRC layer of the UE may perform access barring check, using T305 as “Tbarring” and ac-BarringForMO-Signalling as ACB parameter. Otherwise, i.e. if the establishmentCause is set to MO-Data or HighPriorityAccess-data, the RRC layer of the UE may perform access barring check, using T303 as “Tbarring” and ac-BarringForMO-Data as ACB parameter.

In step S140, the RRC layer of the UE initiates transmission of the RRCConnectionRequest message. The RRC layer of the UE sets the establishmentCause in accordance with the information received from the NAS layer of the UE.

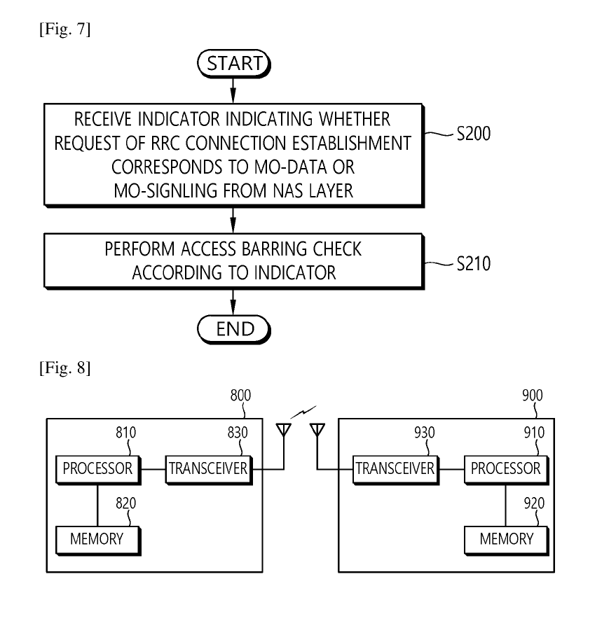

FIG. 7 shows a method for performing ACB according to another embodiment of the present invention. This embodiment of the present invention corresponds to option (2) described in FIG. 6.

In step S200, the RRC layer of the UE receives an indicator indicating whether a request of RRC connection establishment corresponds to MO data or MO signaling from the NAS layer of the UE. The RRC layer of the UE may further receive an establishment cause set to one of either MO signaling or MO data from the NAS layer of the UE. The MO signaling may correspond to a tracking area update procedure. The MO data corresponds to a tracking area update procedure. The RRC layer of the UE may further receive one of call types mapped to originating MMTEL voice, originating MMTEL video, originating SMSoIP, or originating SMS from the NAS layer of the UE.

In step S210, the RRC layer of the UE performs access barring check according to the indicator. When the indicator indicates that the request of RRC connection establishment corresponds to MO data, the access barring check is performed by using ACB parameters for MO data. When the indicator indicates that the request of RRC connection establishment corresponds to MO signaling, the access barring check is performed by using ACB parameters for MO signaling.

FIG. 8 shows a wireless communication system to implement an embodiment of the present invention.

An eNB 800 may include a processor 810, a memory 820 and a transceiver 830. The processor 810 may be configured to implement proposed functions, procedures and/or methods described in this description. Layers of the radio interface protocol may be implemented in the processor 810. The memory 820 is operatively coupled with the processor 810 and stores a variety of information to operate the processor 810. The transceiver 830 is operatively coupled with the processor 810, and transmits and/or receives a radio signal.

A UE 900 may include a processor 910, a memory 920 and a transceiver 930. The processor 910 may be configured to implement proposed functions, procedures and/or methods described in this description. Layers of the radio interface protocol may be implemented in the processor 910. The memory 920 is operatively coupled with the processor 910 and stores a variety of information to operate the processor 910. The transceiver 930 is operatively coupled with the processor 910, and transmits and/or receives a radio signal.

The processors 810, 910 may include application-specific integrated circuit (ASIC), other chipset, logic circuit and/or data processing device. The memories 820, 920 may include read-only memory (ROM), random access memory (RAM), flash memory, memory card, storage medium and/or other storage device. The transceivers 830, 930 may include baseband circuitry to process radio frequency signals. When the embodiments are implemented in software, the techniques described herein can be implemented with modules (e.g., procedures, functions, and so on) that perform the functions described herein. The modules can be stored in memories 820, 920 and executed by processors 810, 910. The memories 820, 920 can be implemented within the processors 810, 910 or external to the processors 810, 910 in which case those can be communicatively coupled to the processors 810, 910 via various means as is known in the art.

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope and spirit of the present disclosure.

1. A method for performing access class barring (ACB) by a user equipment (UE) in a wireless communication system, the method comprising:
receiving, by a radio resource control (RRC) layer of the UE, an indicator indicating whether a request of RRC connection establishment corresponds to mobile originating (MO) data or MO signaling from a non-access stratum (NAS) layer of the UE; and
performing, by the RRC layer of the UE, access barring check according to the indicator.

2. The method of claim 1, wherein when the indicator indicates that the request of RRC connection establishment corresponds to MO data, the access barring check is performed by using ACB parameters for MO data.

3. The method of claim 2, wherein the MO data corresponds to a service request procedure.

4. The method of claim 1, wherein when the indicator indicates that the request of RRC connection establishment corresponds to MO signaling, the access barring check is performed by using ACB parameters for MO signaling.

5. The method of claim 4, wherein the MO data corresponds to a tracking area update procedure.

6. The method of claim 1, further comprising receiving, by the RRC layer of the UE, an establishment cause set to one of either MO signaling or MO data from the NAS layer of the UE.

7. The method of claim 1, further comprising receiving, by the RRC layer of the UE, one of call types mapped to originating multimedia telephony (MMTEL) voice, originating MMTEL video, originating short message service over Internet protocol (SMSoIP), or originating SMS from the NAS layer of the UE.

8. A user equipment (UE) in a wireless communication system, the UE comprising:
a memory;
a transceiver; and
a processor, coupled to the memory and the transceiver, that:
receives an indicator indicating whether a request of a radio resource control (RRC) connection establishment corresponds to mobile originating (MO) data or MO signaling from a non-access stratum (NAS) layer of the UE, and
performs access barring check according to the indicator.

9. The UE of claim 8, wherein when the indicator indicates that the request of RRC connection establishment corresponds to MO data, the access barring check is performed by using ACB parameters for MO data.

10. The UE of claim 9, wherein the MO data corresponds to a service request procedure.

11. The UE of claim 8, wherein when the indicator indicates that the request of RRC connection establishment corresponds to MO signaling, the access barring check is performed by using ACB parameters for MO signaling.

12. The UE of claim 11, wherein the MO data corresponds to a tracking area update procedure.

13. The UE of claim 8, wherein the processor further receives an establishment cause set to one of either MO signaling or MO data from the NAS layer of the UE.

14. The UE of claim 8, wherein the processor further receives one of call types mapped to originating multimedia telephony (MMTEL) voice, originating MMTEL video, originating short message service over Internet protocol (SMSoIP), or originating SMS from the NAS layer of the UE.
